(19) United States
(12) Patent Application Publication
(10) Pub. No.: US 2026/0217501 A1
(43) Pub. Date: Jul. 30, 2026

(54) CORDLESS WINCH

(71) Applicant: MILWAUKEE ELECTRIC TOOL CORPORATION, Brookfield, WI (US)

(72) Inventors: Erik A. Freeberg, Oconomowoc, WI (US); Jarrod P. Kotes, Grafton, WI (US); Anthony R. Sleck, Lisbon, WI (US)

(21) Appl. No.: 19/460,835

(22) Filed: Jan. 27, 2026

Related U.S. Application Data
(60) Provisional application No. 63/750,949, filed on Jan. 29, 2025.

(51) Int. Cl. B66D 1/12; B66D 1/38; B66D 1/46

(52) U.S. Cl. CPC B66D 1/12; B66D 1/38; B66D 1/46

(57) ABSTRACT

A winch includes a housing, a base coupled to the housing, an electric motor disposed inside the housing, a battery pack configured to supply electric current to the electric motor and engageable with a battery receptacle defined on the housing, a spool rotatably supported on the base and driven by the electric motor, and a rope wound around the spool.

### CROSS-REFERENCE TO RELATED APPLICATIONS

This application claims priority to U.S. Provisional Patent Application No. 63/750,949 filed on January 29, 2025, the entire content of which is incorporated herein by reference.

### FIELD OF THE INVENTION

The present invention relates to power tools, and more particularly to powered pulling devices such as winches.

### BACKGROUND OF THE INVENTION

Current winches typically require the winch to be connected to an outside power source, such as the battery of a vehicle. Routing electrical wires and connecting the winch to a power source can be time consuming and difficult.

### SUMMARY OF THE INVENTION

In some aspects, the techniques described herein relate to a winch including a housing, a base coupled to the housing, an electric motor disposed inside the housing, a battery pack configured to supply electric current to the electric motor and engageable with a battery receptacle defined on the housing, a spool rotatably supported on the base and driven by the electric motor, and a rope wound around the spool.

In another aspect, the techniques described herein relate to a winch including a housing, a base coupled to the housing, an electric motor disposed inside the housing, a battery pack configured to supply electric current to the electric motor and engageable with a battery receptacle defined on the housing, a spool rotatably supported on the base and driven by the electric motor, and a chain wound around the spool. The spool includes teeth configured to engage respective links of the chain.

In another aspect, the techniques described herein relate to a winch including a housing, a base coupled to the housing, an electric motor disposed inside the housing, a battery pack configured to supply electric current to the electric motor and engageable with a battery receptacle defined on the housing, a spool rotatably supported on the base and driven by the electric motor, a line wound around the spool, and a plurality of holes defined within the base configured to mount the winch to a support structure.

### BRIEF DESCRIPTION OF THE DRAWINGS

FIG. 1 is a front perspective view of a cordless winch in accordance with an embodiment of the invention.

FIG. 2 is a front perspective view of an alternative embodiment of a cordless winch.

FIG. 3 is a rear perspective view of the cordless winch of FIG. 2.

FIG. 4 is a top view of a remote control for use with the cordless winch of FIG. 2.

FIG. 5 is a perspective view of a hook of the cordless winch of FIG. 2.

FIG. 6 is a front perspective view of a rope guide of the cordless winch of FIG. 2.

FIG. 7 is a front perspective view of an alternative embodiment of the rope guide of the cordless winch of FIG. 2.

FIG. 8 is a side view of a chain come along.

FIG. 9 is a perspective view of a chain sheave of the chain come along of FIG. 8.

FIG. 10 is perspective view of a chain stop.

FIG. 11 is a rear perspective view of an alternative embodiment of a cordless winch.

FIG. 12 is a rear perspective view of an alternative embodiment of a cordless winch.

FIG. 13 is a rear perspective view of an alternative embodiment of a cordless winch.

FIG. 14 is a rear perspective view of an alternative embodiment of a cordless winch.

FIG. 15 is a rear perspective view of an alternative embodiment of a cordless winch.

### DETAILED DESCRIPTION

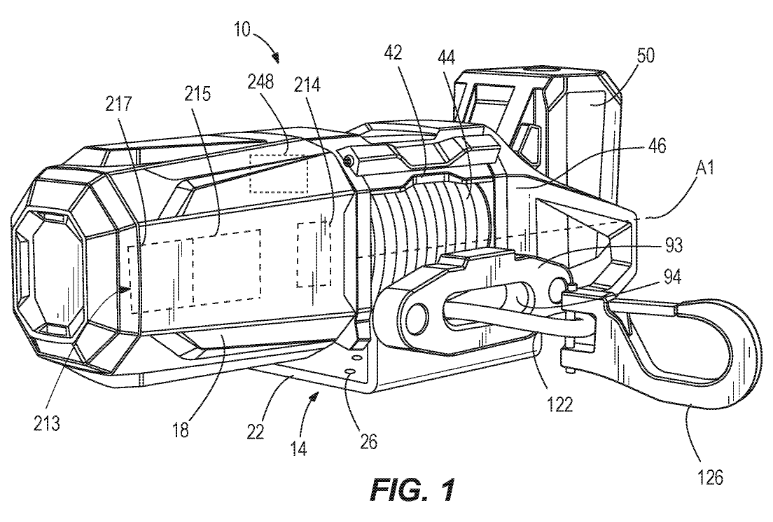

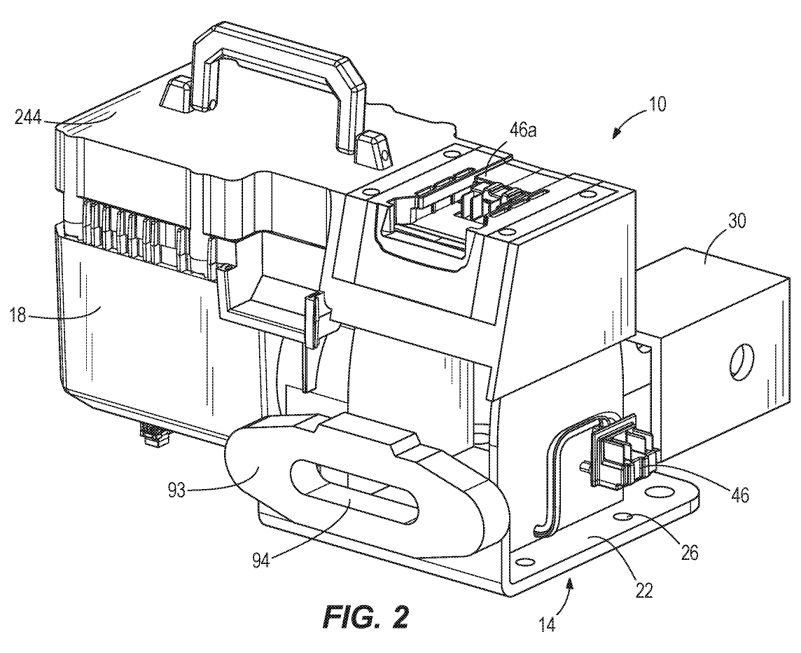

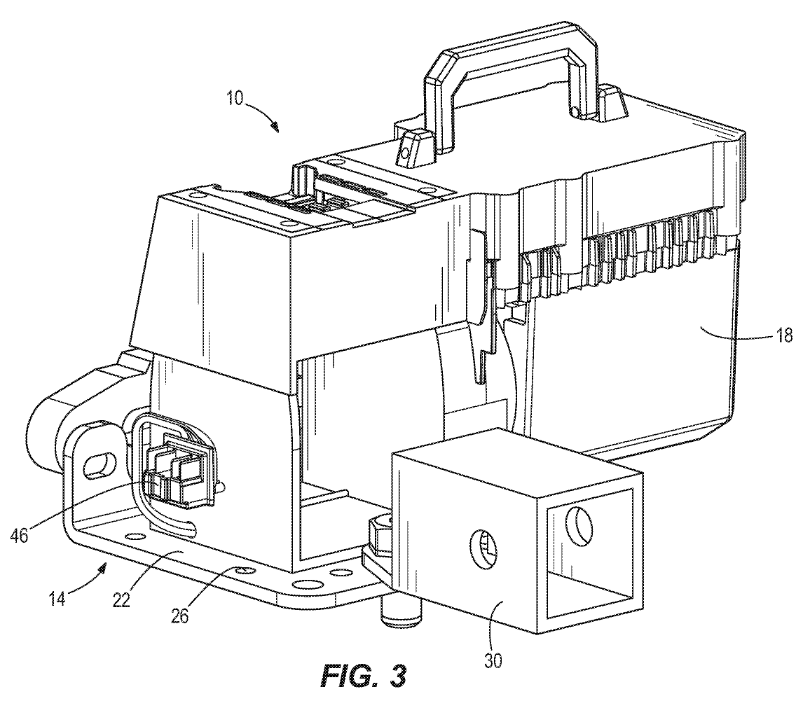

FIG. 1 illustrates a cordless winch 10 that is attachable to a vehicle (e.g., a car, truck, all-terrain vehicle) or a stationary support structure for pulling and moving materials (or the vehicle itself) to a desired location. The winch 10 includes a base 14 and a housing 18 extending from the base 14. The base 14 includes a flange 22 having a plurality of holes 26 through which fasteners or shafts can extend to removably mount the winch 10 to a stationary support structure or a frame of a vehicle, making the winch 10 portable around a job site. In some embodiments, the winch 10 may include a hitch receiver 30 (FIGS. 2 and 3) that is attachable to the trailer hitch on a vehicle.

With reference to FIG. 1, the winch 10 also includes a spool 42 having an axis A1 rotatably supported upon the base 14, a line (e.g., rope 44) wound around the spool 42, and a rope guide 93 coupled to the base 14. In alternative embodiments, the rope 44 can instead be a chain or a steel braided wire. In such embodiments, the spool 42 may instead be configured as a drum or chain wheel, which includes a circular body having a plurality of circumferentially spaced teeth configured to engage with the chain. The teeth are formed with a predetermined pitch and profile to correspond to chain link geometry. The chain wheel may be manufactured from wear-resistant material such as hardened steel, alloy, or composite and may further include surface treatments (e.g. carburizing, coating) to enhance durability and corrosion resistance.

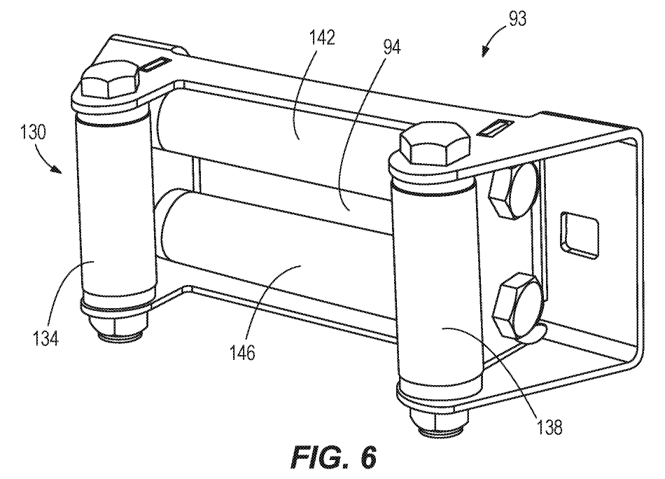

With reference to FIG. 1, the rope guide 93 includes a slot 94 through which the rope 44 extends, and a clevis 122 is secured to the end of the rope 44 with an integrated hook 126. In some embodiments, the slot 94 includes a plurality of rollers 130 (FIG. 6) configured to rotate as the rope 44 is pulled through the slot 94, thereby facilitating a smooth winding or unwinding of the rope 44. The plurality of rollers 130 includes a first lateral roller 134, a second lateral roller 138 parallel to the first lateral roller 134, a first horizontal roller 142 perpendicular to the first lateral roller 134 and the second lateral roller 138, and a second horizontal roller 146 parallel to the first horizontal roller 142. The plurality of rollers 130 at least partially define the perimeter of the slot 94.

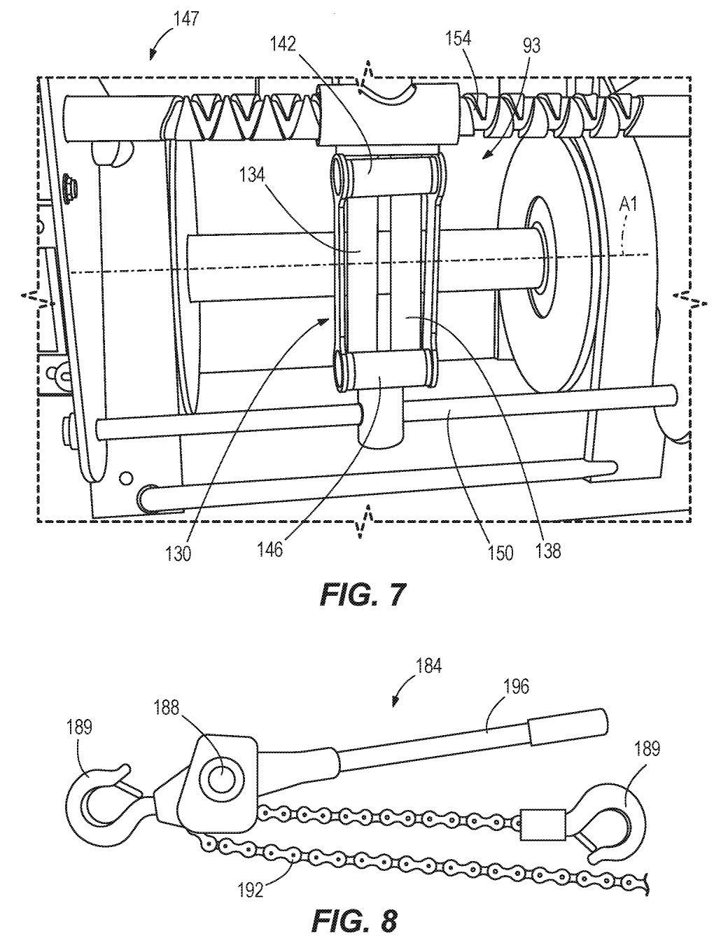

In some embodiments, such as that shown in FIG. 7, the winch 10 includes a level wind mechanism 147 that moves the rope guide 93 relative to the base 14 and the spool 42 to neatly organize the wound rope 44 on the spool 42. In some embodiments, level wind mechanism 147 includes a guide rail 150 along which the rope guide 93 is slidable in a direction that is parallel to the axis A1. The level wind mechanism 147 also includes, in some embodiments, a mechanical linkage (e.g., a lead screw 154) synchronized with rotation of the spool 42 via gears or a chain to reciprocate the rope guide 93 along the guide rail 150 in response to rotation of the spool 42 to distribute the rope 44 evenly across the width of the spool 42. In other embodiments, the rope guide 93 is driven by an electronic actuator controlled by a sensor system configured to monitor the position of the rope 44. In yet another embodiment, the spool 42 or rope guide 93 may include a stop (not shown) that prohibits the rope 44 from being unwound beyond a certain point.

With reference to FIG. 10, in an alternative embodiment, the rope guide 93 is a chain stop 160 through which the chain extends. The chain stop 160 includes a body 164 having a first half 168 and a second half 172 that are fastened together with a plurality of fasteners 176. The first half 168 and the second half 172 each at least partially include a cavity 180 having a profile that corresponds to the chain link geometry. When the first half 168 and the second half 172 are clamped together, the cavity 180 constrains the chain so that the chain is clamped between the first half 168 and second half 172 and passes through the cavity 180 as the chain wheel winds or unwinds the chain. A puck 181 is coupled to a specific point on the chain. The puck has an outer perimeter that is larger than the cavity 180, thus preventing the chain from being unwound past a certain length.

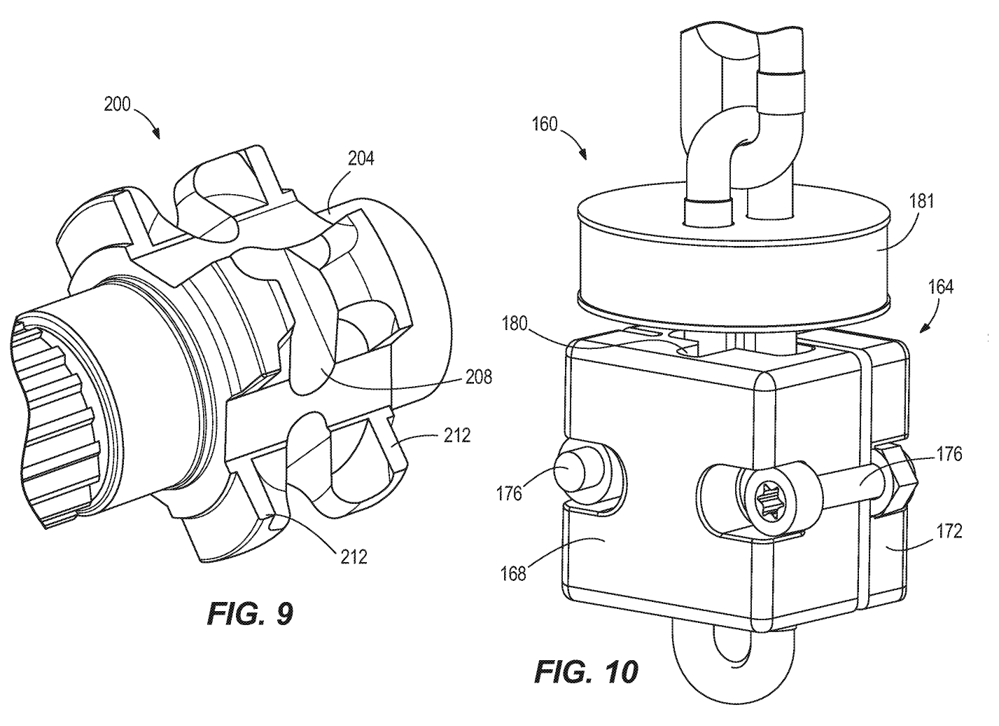

With reference to FIGS. 8-9, in yet another embodiment, the winch 10 can include a chain come along 184. In this embodiment the rope 44 is instead a chain 192, and the chain come along 184 is attached to the chain 192 and is effectively an extension of the chain 192. The chain come along 184 is configured to increase the pulling force of the winch 10 by using mechanical advantage. The come along 184 includes a rotatable drum 188, the chain 192 wound around the drum 188, and a ratcheting mechanism (not shown). The chain ends in a spring-loaded hook 189. The ratcheting mechanism is operatively coupled to the drum 188 to allow incremental advancement of the chain 192 while preventing reverse motion under load. The ratchet may include a pawl and gear to prevent reverse motion and a manual release lever configured to allow controlled unwinding. A handle or lever arm 196 is pivotally coupled to the ratchet mechanism, such that reciprocating movement of the handle 196 rotates the drum 188. The come along 184 further includes a chain sheave 200 (FIG. 9) configured to receive and guide the chain 192 as the drum 188 winds and unwinds the chain 192. The chain sheave 200 includes a circular wheel 204 having a peripheral groove or channel 208 configured to receive the chain 192. The groove 208 includes a profile configured to seat the chain links securely while minimizing wear and friction during operation. In some embodiments, the groove 208 is at least partially formed by a plurality of circumferentially spaced posts 212.

With reference to FIG. 1, the housing 18 extends from a first side of the base 14 that is adjacent the flange 22. The winch 10 further includes a drive unit 213 within the housing 18 that transmits torque to the spool 42 to wind the rope 44 during a pulling operation and an electronic control unit 214 also within the housing 18. In some embodiments, the drive unit 213 is coaxial with the spool 42. In alternative embodiments, the drive unit 213 may be parallel to the axis A1 of the spool 42.

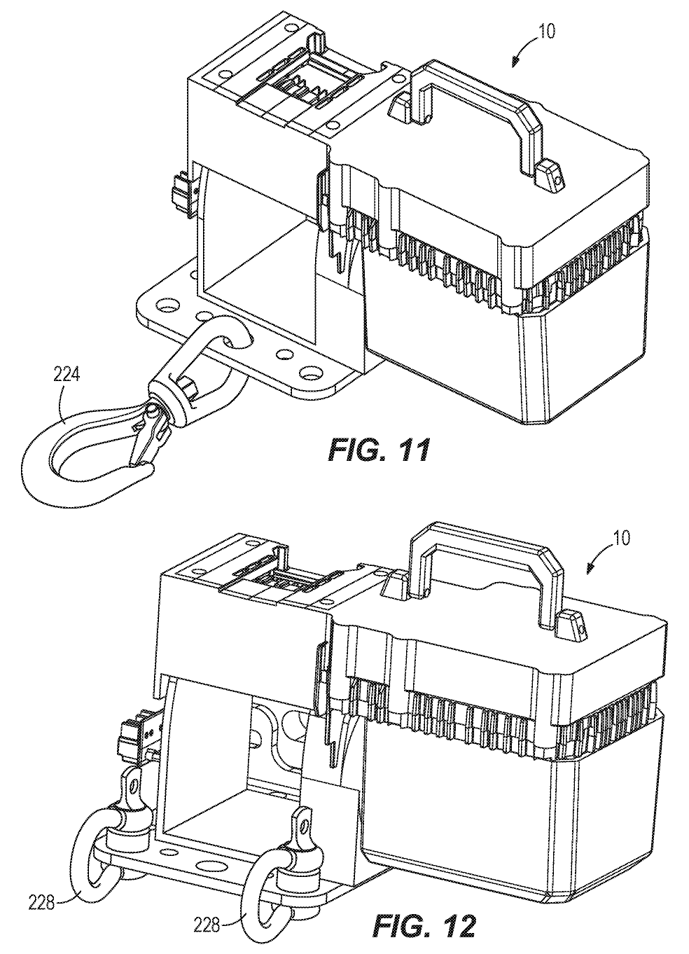

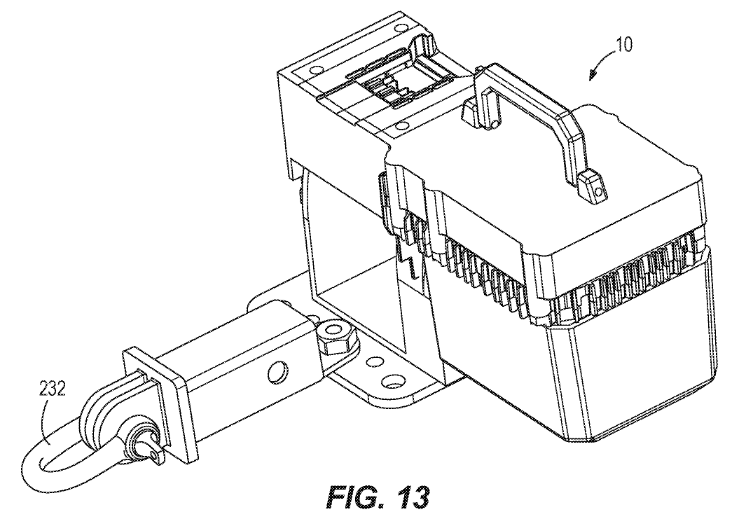

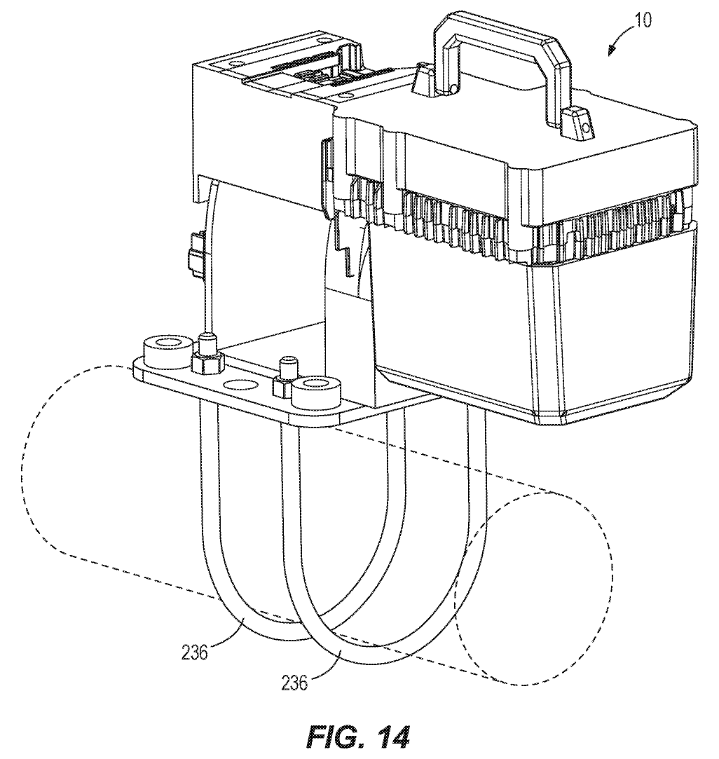

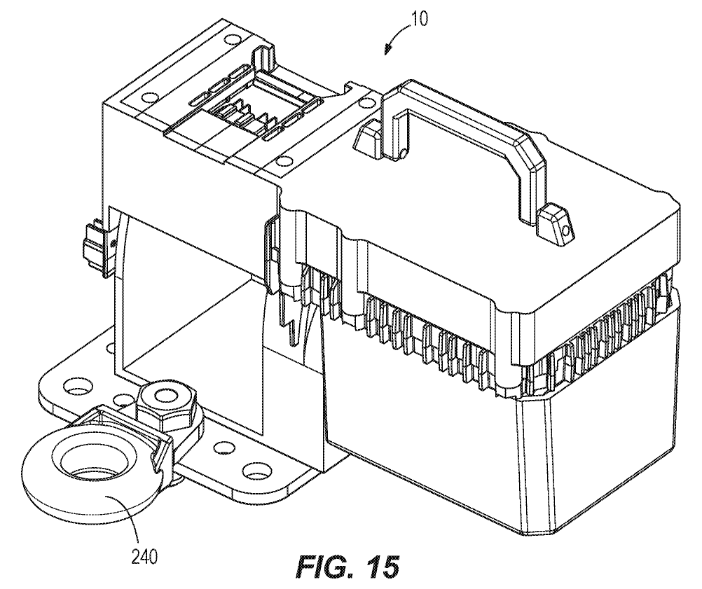

In some embodiments, the winch 10 includes a handle 216 (FIG. 2) disposed on a top surface 220 of the housing 18 and is positioned substantially above the center of gravity of the winch 10 so that the winch 10 is generally balanced when lifted using the handle 216. With reference to FIGS. 11-15, in alternative embodiments, the hitch receiver 30 may be replaced with a hook 224, one or more shackles 228, a clevis 232, a plurality of U-bolts 236, or a lunette ring 240. In yet another embodiment, the plurality of holes 26 allow for any one of the previous attachment structures to be selectively coupled to the flange 22 in place of each other. At least a portion of the housing 18 also may function as a storage box 244 (FIG. 2), configured to hold these various accessories and attachment structures so they are readily available to swap out in place of one another at the user’s discretion.

With reference to FIG. 2, the winch 10 also includes a battery receptacle 46 on a second side of the base 14 that is opposite the first side and also adjacent the flange 22 to which a removable battery pack 50 (FIG. 1) is attachable for supplying electrical current to the drive unit 213 and the electronic control unit. In some embodiments, the battery receptacle 46 may be located on the top surface 220 of the housing 18 (FIG. 2) instead of the second side, or dual battery receptacles 46, 46a may be used for attaching two battery packs to increase the energy capacity available to the drive unit 213 and electronic control unit.

In some embodiments, the drive unit 213 includes a brushless direct current (BLDC) electric motor 217 for supplying torque to the spool 42. The motor 217 includes a power output of at least 1800 W and has a nominal outer diameter of up to 70 mm, when used with a battery pack 50 having a sustained operating discharge current of at least 100 A and a nominal voltage of 20 V or less. Such a motor and battery pack 50 are disclosed in U.S. Patent No. 11,476,527 filed on July 25, 2018, the entire content of which is incorporated herein by reference. In other embodiments, the electric motor 217 may be a BLDC electric motor having a power output of at least 2760 W and a nominal outer diameter of up to 80 mm, when used with a battery pack having a nominal voltage of 80 V and a sustained operating discharge current of between about 40 A and about 60 A. Such a motor and battery pack are disclosed in U.S. Patent No. 11,652,437 filed on July 2, 2018, the entire content of which is incorporated herein by reference.

In some embodiments, the drive unit 213 also includes a transmission or gear train 215 between the motor 217 and the spool 42 to increase the amount of torque supplied to the spool and a clutch between the motor 217 and spool 42. The clutch, when in an engaged state, transmits torque from the motor 217 to the spool 42, causing the spool 42 to wind the rope 44 during a pulling operation. In a disengaged state of the clutch, the spool 42 is rotationally disconnected from the motor 217, permitting the spool 42 to free-wheel and unwind the rope 44 in preparation for a pulling operation.

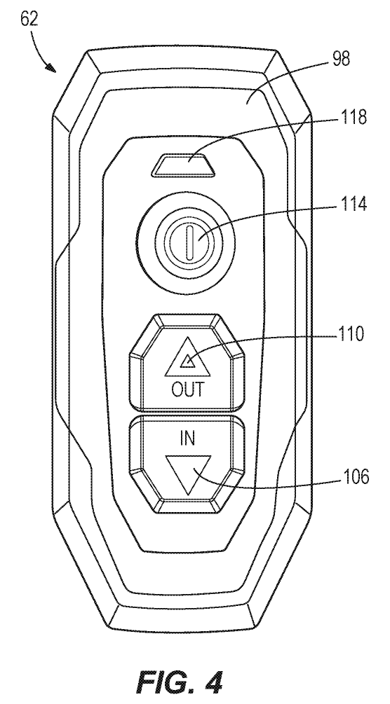

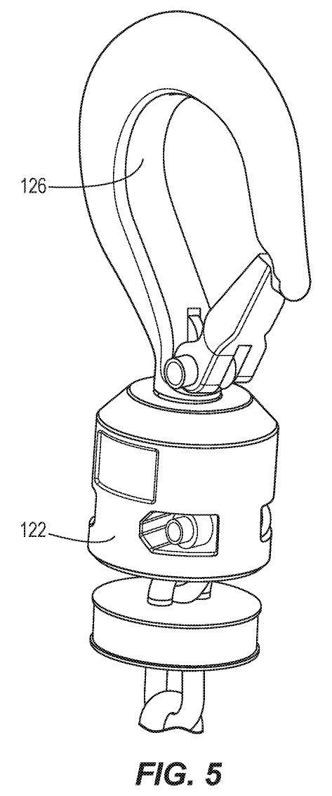

With reference to FIG. 4, a remote control 62 wirelessly communicates with the electronic control unit to control the winch 10 at a distance when a pulling operation is performed. The remote control 62 includes an oblong, generally rectangular housing 98 resembling an automotive key fob, a first user control 106, a second user control 110, a third user control 114, and an indicator 118. The first user control 106, when depressed, is operable to activate the drive unit 213 in a reverse direction to unwind rope 44 from the spool 42. The second user control 110, when depressed, is operable to activate the drive unit 213 in a forward direction to wind rope 44 onto the spool 42. The third user control 114 is operable to de-energize or energize the electronic control unit 10, and the indicator 118 provides a visual alert of the status of the winch 10 (i.e., whether the electronic control unit is energized or not). While the illustrated remote control 62 includes a straight rectangular shape, it should be appreciated that the remote control 62 may have an alternative shape. At the same time, it should be appreciated that the user controls 106, 110, 114 and indicator 118 may take different forms other than buttons or LEDs (e.g., dials, capacitive buttons, etc.). The remote control 62 is also configured to switch the winch 10 between a plurality of operating modes. In one operating mode, the winch 10 is not pulling a load and the motor 217 runs at full speed. In another operating mode, the winch 10 is configured to pull a load at a low speed. In yet another operating mode, the winch 10 is configured to pull a load at a high speed. In yet another operating mode, the spool 42 is disengaged from the motor 217, allowing the user to quickly and easily pull out a length of rope 44. The electronic control unit is also configured to detect if an operating threshold has been exceeded, for example an maximum allowable temperature of the electronic control unit, and will shut the winch 10 off. The indicator 118 may also communicate to the user that the electronic control unit has deactivated the winch 10.

In some embodiments, the winch 10 includes an onboard user interface 248 in communication with the electronic control unit. The user interface 248 may include the same user controls described above on the remote control 62.

Various features of the invention are set forth in the following claims.

What is claimed is:

1. A winch comprising:
a housing;
a base coupled to the housing;
an electric motor disposed inside the housing;
a battery pack configured to supply electric current to the electric motor and engageable with a battery receptacle defined on the housing;
a spool rotatably supported on the base and driven by the electric motor; and
a rope wound around the spool.

2. The winch of claim 1, wherein the base includes a plurality of holes configured to mount the winch to a support structure.

3. The winch of claim 2, wherein the holes are defined within a flange of the base.

4. The winch of claim 1, further comprising a rope guide coupled to the base.

5. The winch of claim 4, wherein the rope guide includes a plurality of rollers with which the rope is engageable in response to the rope being wound on the spool or unwound from the spool.

6. The winch of claim 5, further comprising a level-wind mechanism configured to move the rope guide relative to the spool to evenly distribute the rope around the spool as the rope is wound around the spool.

7. The winch of claim 6, wherein the level-wind mechanism includes a guide rail along which the rope guide is slidable and a rotatable lead screw for moving the rope guide along the guide rail.

8. The winch of claim 1, further comprising a transmission positioned between the electric motor and the spool, wherein the transmission is configured to increase an output torque from the electric motor.

9. The winch of claim 1, wherein the spool and the electric motor are one of coaxial or parallel to each other.

10. The winch of claim 1, further comprising an electronic control unit within the housing, wherein the electronic control unit is configured to selectively activate and deactivate the electric motor in response to a user input signal.

11. The winch of claim 10, further comprising a remote control configured to wirelessly transmit the user input signal to the electronic control unit.

12. The winch of claim 10, further comprising a user interface supported upon the housing, wherein the user interface is configured to transmit the user input signal to the electronic control unit.

13. A winch comprising:
a housing;
a base coupled to the housing;
an electric motor disposed inside the housing;
a battery pack configured to supply electric current to the electric motor and engageable with a battery receptacle defined on the housing;
a spool rotatably supported on the base and driven by the electric motor; and
a chain wound around the spool,
wherein the spool includes teeth configured to engage respective links of the chain.

14. The winch of claim 13, wherein the teeth are formed with a pitch that corresponds to a pitch of the respective links of the chain.

15. The winch of claim 13, further comprising a chain stop through which the chain extends.

16. The winch of claim 15, wherein the chain stop is configured to limit a length of chain that can be unwound from the spool.

17. The winch of claim 13, further comprising a come along attachable to the chain and configured to increase a pulling force of the winch.

18. The winch of claim 17, wherein the come along includes a chain sheave to guide and support the chain in response to the come along winding and unwinding the chain.

19. A winch comprising:
a housing;
a base coupled to the housing;
an electric motor disposed inside the housing;
a battery pack configured to supply electric current to the electric motor and engageable with a battery receptacle defined on the housing;
a spool rotatably supported on the base and driven by the electric motor;
a line wound around the spool; and
a plurality of holes defined within the base configured to mount the winch to a support structure.

20. The winch of claim 19, further comprising one of a hitch receiver, a hook, a clevis, a shackle, a U-bolt, or a lunette ring secured to the base via the holes.
